(19) United States
(12) Patent Application Publication
(10) Pub. No.: US 2026/0146726 A1
(43) Pub. Date: May 28, 2026

(54) TILT-ADAPTING LIGHTING SYSTEM

(71) Applicant: Federal Signal Corporation, Downers Grove, IL (US)

(72) Inventors: Duane P. Belitz, Frankfort, IL (US); Edward Stanuch, Frankfort, IL (US)

(21) Appl. No.: 19/395,098

(22) Filed: Nov. 20, 2025

Related U.S. Application Data
(60) Provisional application No. 63/725,583, filed on Nov. 27, 2024.

(51) Int. Cl. F21S 43/31; B60Q 1/00; B60Q 1/26; F21S 4/28; F21S 43/14; F21S 43/40; F21V 7/09; F21V 23/00; F21W 103/30; F21Y 103/10; F21Y 115/10

(52) U.S. Cl. CPC F21S 43/31; B60Q 1/0017; B60Q 1/2661; F21S 4/28; F21S 43/14; F21S 43/401; F21V 7/09; F21V 23/004; F21W 2103/30; F21Y 2103/10; F21Y 2115/10

(57) ABSTRACT

Lighting system for a vehicle with a tilting component, such as a tilting truck bed. The lighting system can be mounted to the tilting component. In an example, the lighting system includes differently configurable reflectors for generating light beams that propagate at different angles to improve the lighting system's efficacy even when the tilting component is tilted.

### RELATED APPLICATIONS

This patent application is related to U.S. Patent Application Publication Nos. 2019/0329702 and 2014/0125476, the contents of which are hereby incorporated by reference in their entireties.

### BACKGROUND

Vehicles are commonly equipped with signal lights. Brake lights, for example, when illuminated, indicate that brakes have been applied in the vehicle. Turn signal lights, when flashing, indicate that a vehicle may be intending to make a left or a right turn. Reverse lights, when illuminated, indicate that a vehicle is in reverse gear. Specialty vehicles, such as commercial vehicles, emergency vehicles, tow trucks, construction, and maintenance vehicles commonly include additional signal lights such as warning lights. In some vehicles, multiple warning lights are positioned in a lightbar that is affixed to a vehicle, and the warning lights of the lightbar are configured to illuminate or flash in a coordinated manner. On some vehicles, such as wreckers, lightbars can be mounted to portions of the vehicle that are designed to tilt, such as the truck bed.

### SUMMARY

In general terms, the present disclosure is directed to a lighting system that is configured to adapt to being tilted.

In further general terms, the present disclosure is directed to a lightbar that is configured to adapt to being tilted.

In further general terms, the present disclosure is directed to a vehicle to which is mounted a light system or lightbar that is configured to adapt to being tilted.

In further general terms, the present disclosure is directed to a method assembling a lighting system to enable the light system to adapt to being tilted.

According to one aspect, a lighting system includes: a lighting device, the lighting device including: a housing; a lens mounted to the housing; a first reflector positioned in the housing; and a light emitter positioned in the housing, the lighting device being configured such that a peak magnitude of a light beam distribution emitted by the light emitter through the lens is along a first direction; and a second reflector configured to be mounted to the lighting device, the second reflector being configured such that when the second reflector is mounted to the lighting device, the peak magnitude of the light beam distribution emitted by the light emitter through the lens is along a second direction, the second direction and the first direction being at least 5 degrees offset from each other.

According to another aspect, a lightbar for a vehicle includes: a housing; a lens mounted to the housing; a first light assembly positioned in the housing, the first light assembly including a first light emitter and a first reflector; a second light assembly positioned in the housing, the second light assembly including a second light emitter and a second reflector, wherein the first light emitter and the second light emitter are configured to generate light beams having light beam distributions in which directions of peak magnitudes of the light beam distributions are parallel to each other; and wherein the first reflector and the second reflector are configured to reflect the light beams such that reflected directions of the peak magnitudes of the light beam distributions are offset from each other by at least five degrees.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 depicts a prior art adjustable warning lighting unit.

FIG. 2 is a side view of a schematic representation of a vehicle with an untilted tiltable bed and an example lighting system mounted to the bed.

FIG. 3 is a side view of a schematic representation of the vehicle of FIG. 3, with a tilted bed.

FIG. 4 is a top, planar view of an example embodiment of the lighting system of FIG. 2.

FIG. 5 is a perspective view of a portion of the lighting system of FIG. 4.

FIG. 6 is a further perspective view of the portion of the lighting system of FIG. 5.

FIG. 7 is a partially exploded, perspective view of the portion of the lighting system of FIG. 5.

FIG. 8 is a perspective view of a further portion of the lighting system of FIG. 4.

FIG. 9 is an enlarged, perspective view of a further portion of the lighting system of FIG. 4.

FIG. 10 is a top, planar view of a further portion of the lighting system of FIG. 4.

FIG. 11 is an enlarged, perspective view of a further portion of the lighting system of FIG. 4.

FIG. 12 is a perspective view of a reflector of the lighting system of FIG. 4.

FIG. 13 is a further perspective view of the reflector of FIG. 12.

FIG. 14 is a planar, end view of the reflector of FIG. 12.

FIG. 15 is a cross-sectional view of the reflector of FIG. 12 along the line 15-15 in FIG. 14.

FIG. 16 is a perspective view of a further example reflector of a lighting system.

FIG. 17 is a further perspective view of the reflector of FIG. 16.

### DETAILED DESCRIPTION

The present disclosure is directed towards lighting systems, lightbars, vehicles with lightbars, and associated methods. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Certain vehicles, such as industrial vehicles, commercial vehicles, emergency vehicles, and the like, have tilting components. For instance, a rollback wrecker has a tilting bed (including a platform) for recovering stranded vehicles. Recovery is usually at the roadside. Warning lights mounted to the wrecker are typically activated while performing a recovery. The tilting bed typically has a lightbar mounted at the front of the bed. However, as the bed is tilted, the warning light beam signal diverts from optimal aiming. While the bed is tilted is also the time during which operators of the wrecker and others in the vicinity are in the most danger as they often work on foot around the bed of the truck.

Solutions exist to adjust the beam angle of the light emitted from lighting units to adapt to a tilted position, but these solutions suffer from various drawbacks.

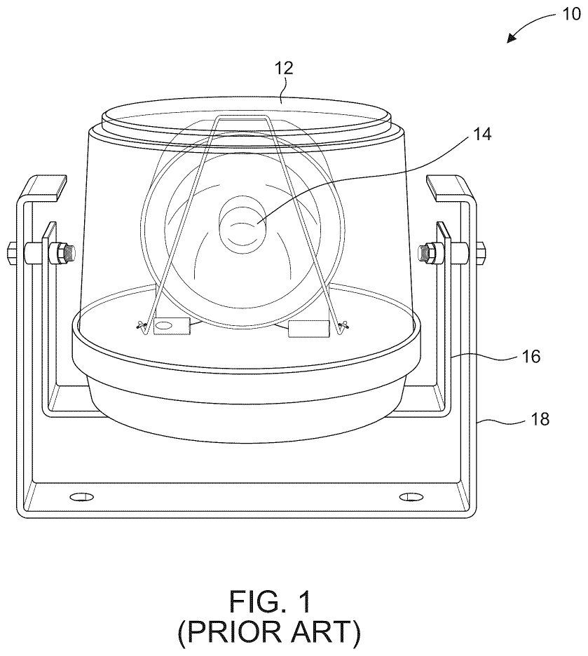

FIG. 1 depicts a prior art adjustable warning light 10. The light 10 includes a partially transparent housing 12 housing a rotating bulb 14. The housing 12 is mounted to a first U-bracket 16. The first U-bracket 16 is pivotally fastened to a second U-bracket 18, which is configured to be mounted to a vehicle. Due to the pivotal cooperation of the first and second U-brackets 16 and 18, the direction of beam propagation from the bulb 14 can be maintained to some degree when the overall unit 10 is tilted relative to the force of gravity.

The warning light 10 suffers from several disadvantages including, e.g., a high weight, a large amount of material needed for the mechanical components, and high maintenance costs for maintaining the mechanical components in operable condition.

Other existing solutions suffer from high complexity, which can result in premature failure of the lighting system or portions of the lighting system, and/or lack of customizability of the lighting system. For example, there is a need for a lighting system designed for non-tilting implementations but that can be easily reconfigured to adapt to tilting configurations. Examples of lighting systems described herein can overcome one or more of these drawbacks and limitations of existing lighting systems.

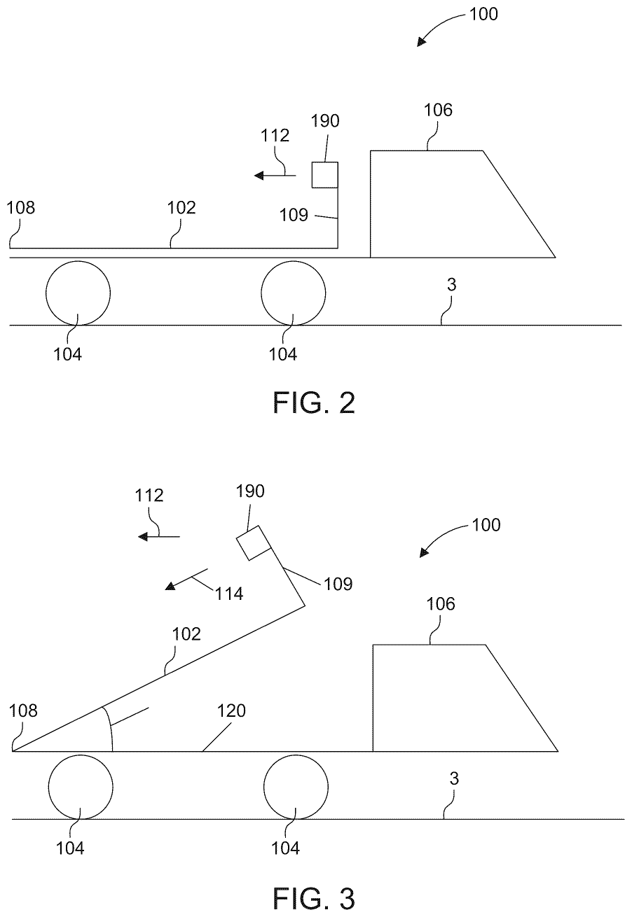

Referring to FIGS. 2 and 3, an object 100 is schematically represented in profile. In this example, the object 100 is a vehicle (e.g., a wrecker) with a tiltable bed 102. The vehicle 100 includes wheels 104 that rest on the ground 3, and a cab 106. The ground 3 can be perpendicular to the force of gravity, but need not be.

The tiltable bed 102 has a front wall 109 and back end 108. A lighting system for generating warning light signals can be mounted to any desirable location on the vehicle 100, such as at the back end 108 of the bed 102. In this example, a lighting system 190 is mounted at the top of the front wall 109 of the bed 102.

For a typical lightbar mounted to the front wall 109 of the truck bed 102, light beams will be focused (e.g., have maximum amplitude) along the direction 112 (parallel to the ground 3) in FIG. 2 when the bed 102 is in the fully lowered position, but along the direction 114 in FIG. 3 when the bed 102 is in a tilted up position. The tilted down direction 114 is defined by an angle α between the vehicle's chassis 120 and the bed 102. That is, in the vehicle's tilted up position, the light beams generated by a typical lighting system will be angled downward by an offset angle commensurate (e.g., within 1 degree or 2 degrees) with the angle α.

The angle α can be any number of degrees greater than 0 degrees and less than or equal to 90 degrees. In the case of certain wreckers when fully tilted, the angle α is in a range from about 5 degrees to about 20 degrees, or in a range from about 10 degrees to about 20 degrees, or in a range from about 13 degrees to about 17 degrees, or about 10 degrees, or about 15 degrees.

Focusing the light beams in the direction 114 when the bed 102 is tilted is suboptimal, since the light beams may be obscured or insufficiently bright to provide adequate warning for individuals (e.g., drivers in vehicles) that are located behind the wrecker 100.

A lighting system 190 according to the present disclosure is mounted to the front wall 109 of the bed 102. The lighting system 190 is configured to emit a light beam that is focused in the direction 112 (parallel to the ground) even with the bed 102 is tilted, thus providing enhanced alerting and warning characteristics.

Thus, whether the tiltable bed 102 is tilted or not, light generated by the lighting system 190 is focused parallel to the ground 3 such that light is visible from behind the vehicle 100, thereby improving the safety of the vehicle 100.

In some examples, the light emitted by the lighting system 190 and focused along the direction 112 when the bed 102 is not tilted differs in one or more indicia from the light emitted by the lighting system 190 and focused along the direction 112 when the bed 102 is tilted, such that it can be visually determined whether the bed 102 is tilted or not tilted based on the indicia presented. Such indicia can include, for example, colors or wavelength bands, flash patterns, beam width, beam brightness, etc.

The lighting system 190 can be mounted to the front wall 109 (or another part of the vehicle) by any suitable means, such as with one or more fasteners and/or with adhesive.

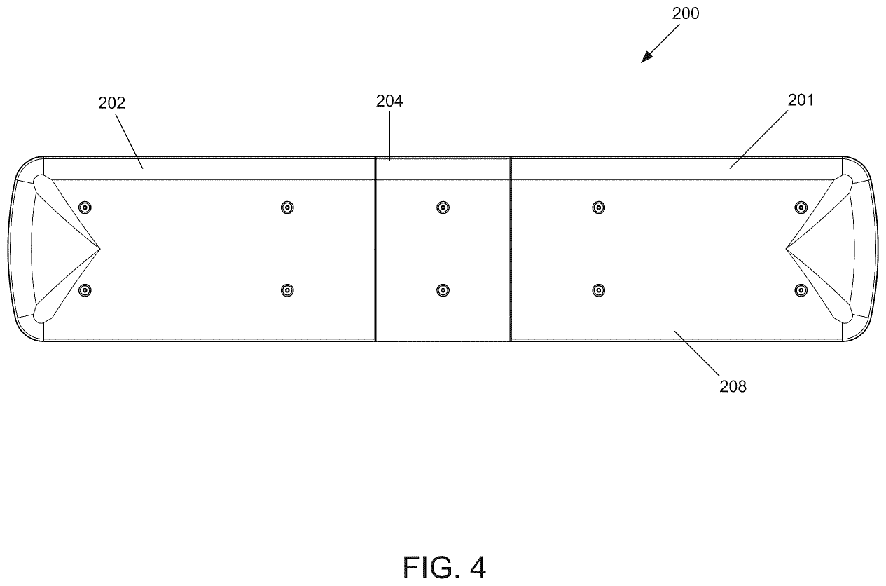

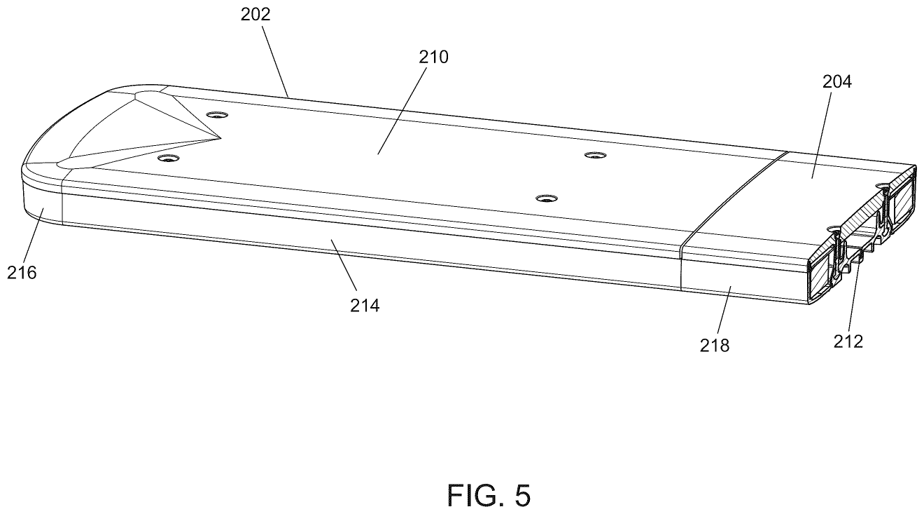

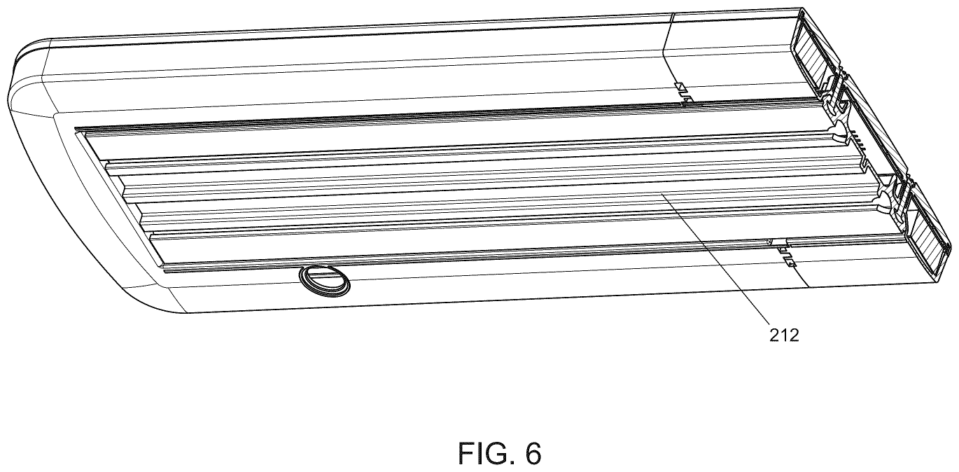

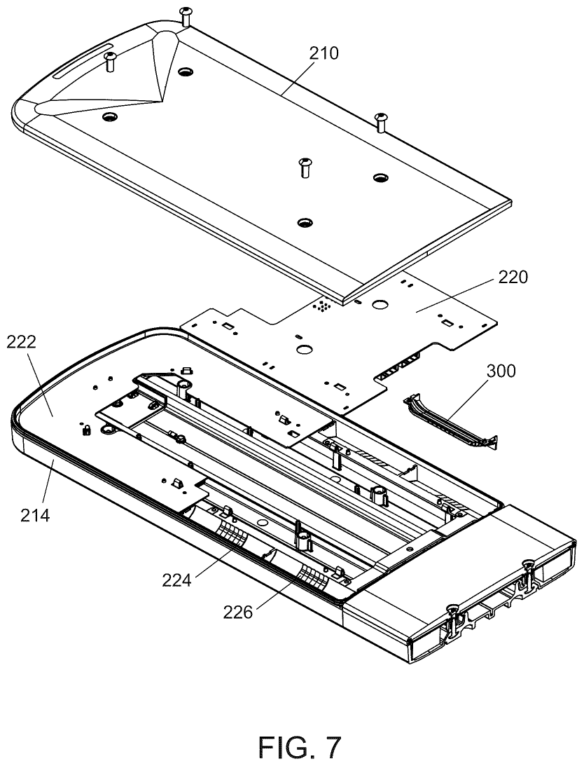

Referring to FIGS. 4-11, aspects of a lighting system 200 will now be described. The lighting system 200 is an example embodiment of the lighting system 190 of FIGS. 2-3.

The lighting system 200 includes a lightbar 201. In this example, the lightbar 201 is constructed of three modules 202, 204 and 208 that are removably fastened together. Two end modules 202 and 208 are connected to opposite sides of a central module 204. The lightbar can be increased or decreased in size by adding or removing additional modules.

Each module 202, 204, 208 can include a dedicated printed circuit board (PCB) operatively connected to light emitters, such as LEDs, halogen bulbs, and the like. A central controller, stored in the lightbar 201, or externally thereto, e.g., in another portion of the vehicle, generates control signals that can independently activate the light emitters of the different modules 202, 204, and 208. The controller generates logic control signals based on user input via an interface typically located within the cab of the vehicle (e.g., a touch screen, or one or more physical switches and/or buttons). The interface, controller and PCBs are operatively connected via wires and/or can be configured to communicate with each other via wireless communications. The lightbar 201 can house its own dedicated power supply to generate the electricity needed to operate the lightbar, and/or receive power from somewhere else on the vehicle, such as the vehicle's battery. A power cord from the battery can be plugged into the lightbar 201 to provide electrical current to the lightbar 201.

The lightbar 201 is an example lighting device. The lightbar 201 includes a housing that houses various components. In this example, the housing includes a top housing piece 210 and a bottom housing piece 212 that are mated to each other and define an interior volume of the lightbar 201 in which various electrical and optical components are positioned and mounted.

The lightbar 201 includes lenses (such as lenses 214, 216, 218) arranged around a portion or around the entire perimeter of the lightbar. The lenses are at least partially transparent and are configured to focus and/or otherwise transmit light beams emitted from lighting units positioned within the housing of the lightbar 101. The lenses are attached to one or both of the housing pieces 210 and 212.

The housing of the lightbar 201 includes discrete lighting units positioned around a portion or the entirety of the perimeter of the lightbar 201. The lighting units are powered and controlled by PCBs (e.g., the PCB 220, the PCB 222) to generate light beams that propagate through the corresponding lens associated with a given lighting unit. The discrete lighting units can be controlled independently of one another by one or more controllers, allowing a large variety of flashing patterns, warning signals, and combinations to be generated by the lightbar 201.

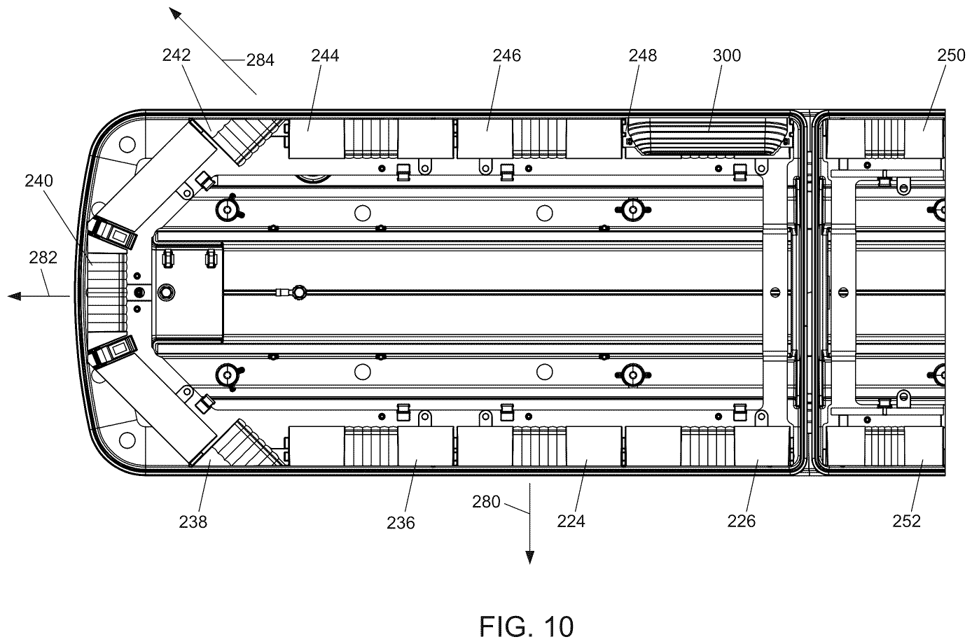

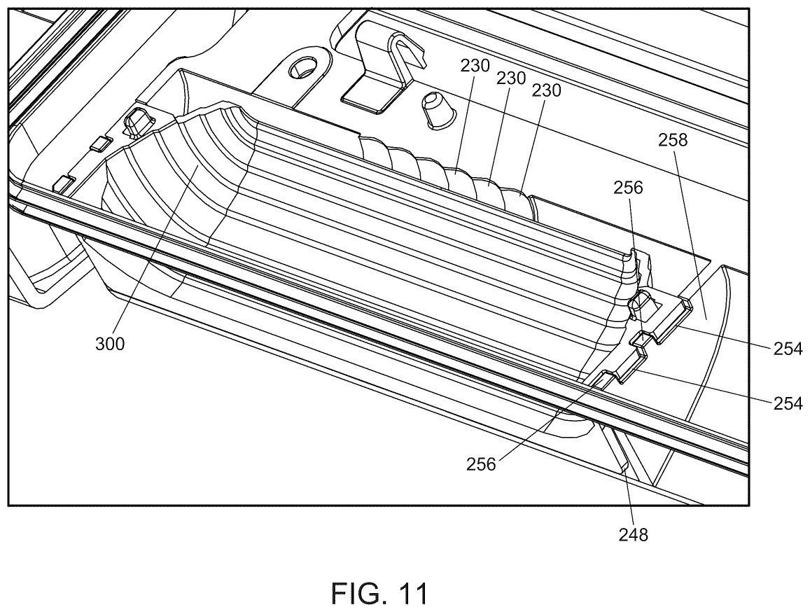

Half of the lighting units of the lightbar 201 are shown in FIG. 10. These lighting units 224, 226, 236, 238, 240, 242, 244, 246, 248 and 250 are positioned in the module 202 and the module 204. Each lighting unit is covered by the corresponding lens.

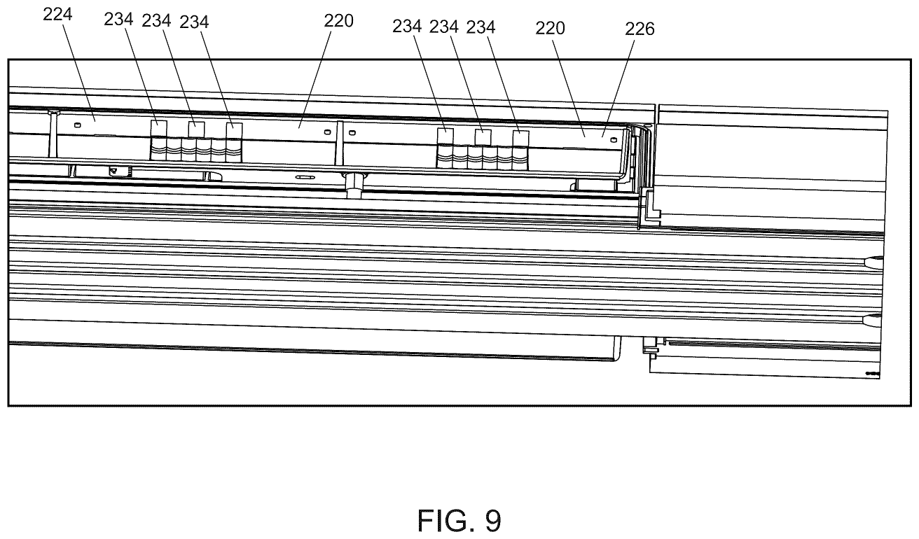

Each lighting unit includes one or more light emitters configured to emit light according to control signals generated by a PCB. For instance, as shown in FIG. 9, the lighting units 224 and 226 each include light emitters 234 (schematically shown) mounted to the underside of the PCB 220. The light emitters can be any suitable light emitters, such as LEDs, halogen bulbs, and the like.

Each lighting unit is configured such that the light beam generated by the light emitter is reflected and focused through the corresponding lens. For example, referring to FIG. 10, light emitted by the lighting unit 224 is focused along the direction 280 heading away from the lightbar 201, light emitted by the lighting unit 240 is focused along the direction 282 heading away from the lightbar 201, and light emitted by the lighting unit 242 is focused along the direction 284 heading away from the lightbar 201. Referring to FIGS. 2, 3 and 10, each of the directions 280, 282 and 284 are in the same plane parallel to the ground 3 as the arrow 112 in FIG. 2, and in the same tilted (from the plane of the ground 3) plane as the arrow 114 in FIG. 3.

To achieve the light beam focus along these directions, each lighting unit, or at least one or more of the lighting units, includes a reflector 229. The reflector 229 defines curved, concave reflective surfaces 230. The reflector 229 can be constructed of a smooth, transparent material (e.g., clear plastic or glass) with a reflective backing (e.g., silver). The transparent material and backing follow the contours of the curved surfaces 230. Alternatively, the reflector 229 can include a rigid (e.g., plastic) body, with a reflective external coating deposited thereon.

The configurations of the surfaces 230 and their positioning relative to the corresponding light emitter(s) of the corresponding lighting unit are such that, when the lightbar 201 is properly mounted to the bed 102, the peak magnitude of the light beam distribution emitted by the corresponding one or more light emitters of the same lighting unit through the portion of the lens corresponding to the lighting unit is in the same plane parallel to the ground 3 as the arrow 112 in FIG. 2, and in the same tilted (from the plane of the ground 3) plane as the arrow 114 in FIG. 3.

The system 200 also includes one or more reflectors 300, which are configured differently than the reflectors 229. The reflector 300 is a collimator.

The reflector 300 is configured to be installed in a lighting unit. When installed, the reflector 300 can cover or partially cover the corresponding reflector 229. In this manner, light generated by the corresponding light emitter(s) of the lighting unit reflects off the reflector 300 to the exclusion of or in addition to the corresponding reflector 229. The reflector 300 defines curved, reflective surfaces that are differently configured than the surfaces 230 of the reflector 229. The reflector 300 can be constructed of transparent material (e.g., clear plastic or glass) with a reflective backing (e.g., silver). The transparent material and coating follow the contours of the curved surfaces of the reflector 300. Alternatively, the reflector 300 can include rigid (e.g., plastic) body, with a reflective external coating deposited thereon.

The configurations of the reflector 300 and its positioning relative to the corresponding light emitter(s) of the corresponding lighting unit are such that the peak magnitude of the light beam distribution emitted by the corresponding one or more light emitters of the same lighting unit through the portion of the lens corresponding to the lighting unit is in the same plane parallel to the ground 3 as the arrow 112 in FIG. 3, even when the bed 102 is tilted.

Advantageously, the system 190 can be configured with the desired number and placement of reflectors 300 installed in one or more of the lighting units, e.g., alternating placement of reflectors 300 and nonplacement of reflectors 300 in the lighting units around the perimeter of the lightbar 201. In another example of many, one or more reflectors 300 can be installed in lighting units of the lightbar 201 facing the rear of the vehicle and/or one or more of the sides of the vehicle, whereas no reflectors 300 are installed in lighting units of the lightbar facing the front of the vehicle. In this manner, the system 190 can be configured according to a large variety of customizable configurations to direct peak magnitude light beam distributions both in the plane parallel to the ground 3 and the tilted plane in FIG. 3.

In addition, the lightbar 201 can be programmed to generate separate coordinated warning signal patterns (e.g., flash patterns) for the lighting units that include reflectors 300 and a different warning signal pattern for the lighting units that do not include reflectors 300, such that different warning signal patterns are presented in the direction 112 (FIGS. 2-3) depending on whether the bed 102 of the vehicle 100 is tilted or not tilted.

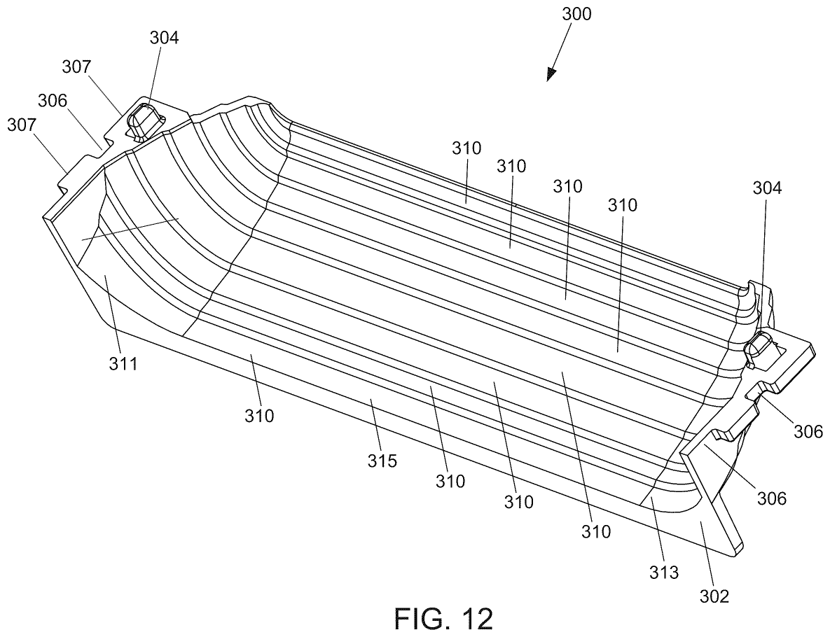

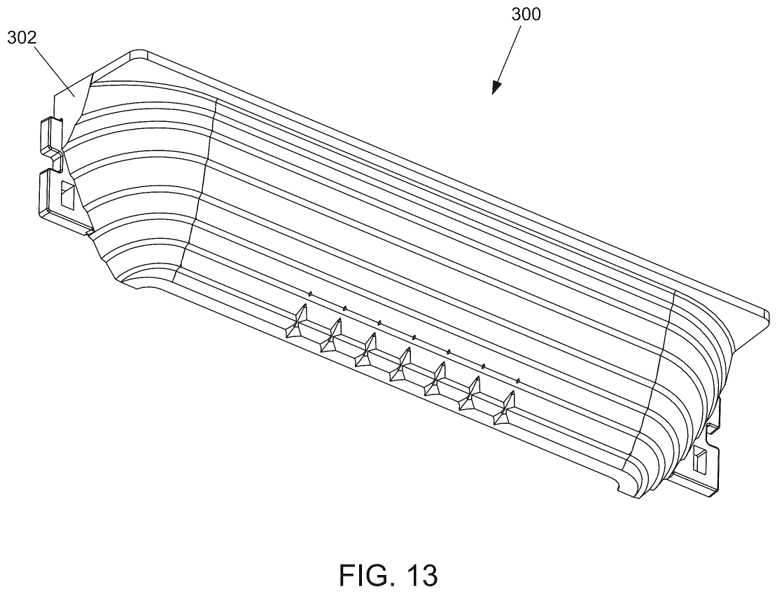

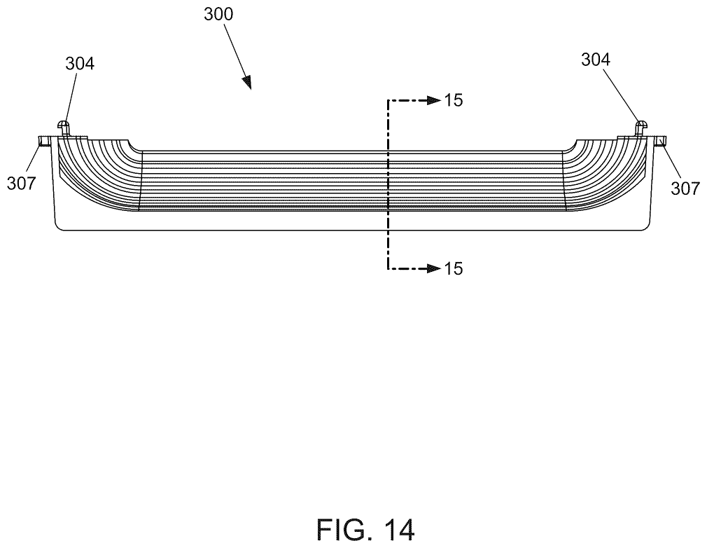

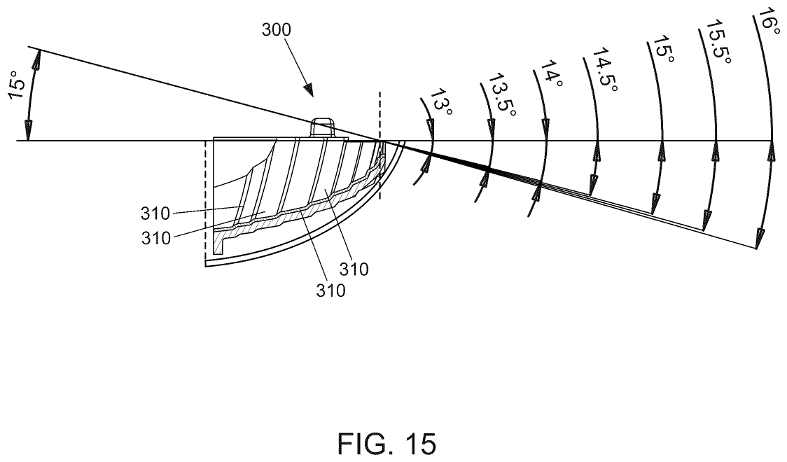

Referring to FIGS. 12-15, the reflector 300 includes a body 302. The body 302 defines a series of curved reflective surfaces 310 that form a collimator. The reflective surfaces 310 have a stepped configuration in cross section (FIG. 15). A central line through the stepped cross-section defines, or approximately defines, a parabolic curve.

As shown in FIG. 15, optical axes of the surfaces 310 are angled relative to the ground when the reflector 300 is installed in a lighting unit that is installed on a vehicle. The parabolic curve is such that in some examples the optical axes of the surfaces 310 increase in angle relative to the ground between about 13 degrees and about 16 degrees along the parabolic curve to provide a beam direction parallel to the ground in a tilted state.

Each surface 310 has two curved side portions 311, 313, and a straight (or less curved) central portion 315 positioned between and connecting the side portions 311 and 313.

Elongate dimensions of the surfaces 310 are perpendicular, or approximately perpendicular, to elongate dimensions of the curved surfaces 230 when the reflector 300 is mounted to a lighting unit and covering or partially covering the corresponding reflector 229 (FIG. 11).

In some examples, each curved surface 230 is concave, whereas at least the central portion 315 of each curved surface 230 is not concave.

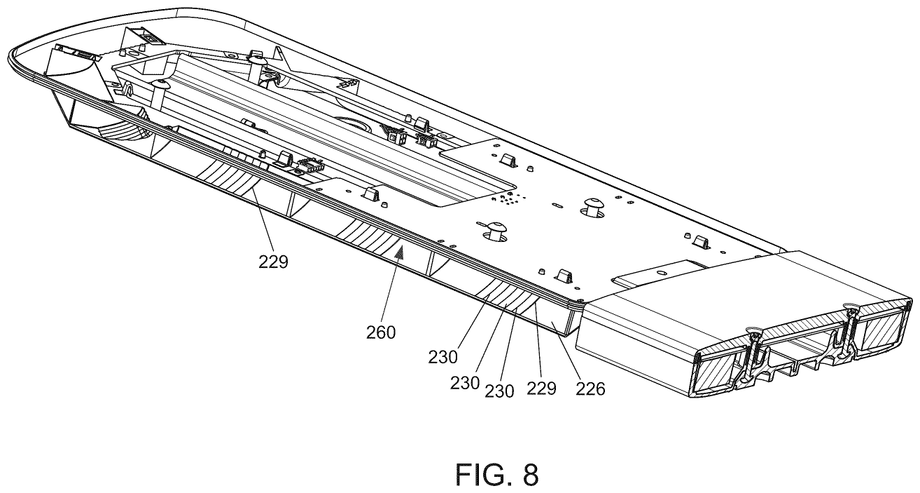

The body 302 defines mounting structures. The mounting structures can include projections 307 and recesses 306 that are complementary, respectively, with receivers 254 and projections 256 of side walls 258 of the lighting units (FIG. 11). For example, these mounting structures can enable the reflector 300 to be inserted into the cavity 260 (FIG. 8) defined by a lighting unit and secured, e.g., by frictional fit, to the side walls of the lighting unit that partially define the cavity. Optionally, the body 302 of a reflector 300 can also include one or more hooks 304 to assist in further securing the reflector 300 to another portion of the lightbar 201, such as a piece of the housing.

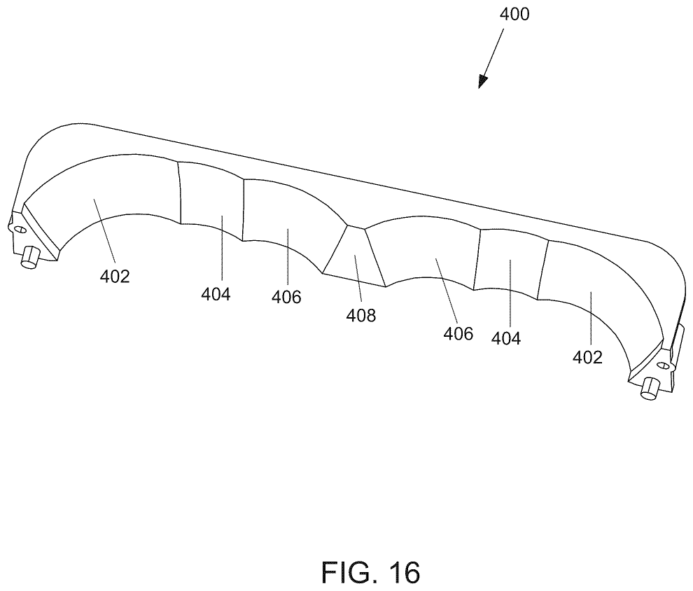

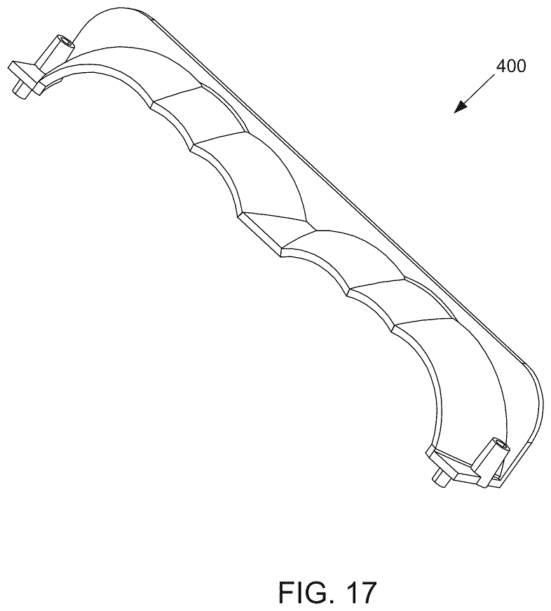

Referring to FIGS. 16-17, another example configuration of a tilting reflector 400 is shown. The reflector 400 can be used instead of the reflector 300 to achieve a similar beam reflecting result as the reflector 300. In some examples, a lighting system can include one or more reflectors 300 and one or more reflectors 400 installed in different lighting units of a lightbar or other lighting device.

The reflector 400 includes curved reflective surfaces 402, 404, 406 that, collectively, are configured to focus some of the light from the corresponding light emitter(s) along the direction 112 in FIG. 2, some of the light from the corresponding light emitter(s) along the direction 112 in FIG. 3, and some of the light from the corresponding light emitter(s) along the direction 114 in FIG. 3. That is, the reflector 400 is configured to focus light in two directions at the same time, one direction corresponding to parallel to the ground when the lighting device is not tilted, and the other direction corresponding to parallel to the ground with the lighting device is tilted. To achieve these multiple directions of focus, the curved surfaces are arranged in two sets of each surface 402, 404, 406, with the sets divided by a trapezoidal dividing surface 408. In addition, the curvature of the surfaces 402, 404 and 406 are distinct one from another and discontinuous one with another.

In some examples, different lighting units of a lightbar or other lighting device can be activated and not activated depending on whether the vehicle is in a tilted configuration. For example, only the lighting units that have a reflector 300 installed therein have their light emitters activated when the vehicle is in a tilted configuration, whereas only those lighting units that do not have a reflector 300 installed therein have their light emitters activated when the vehicle is not in a tilted configuration.

To achieve tilt-based activation and deactivation of light emitters of different lighting units, the lighting system can be equipped with an orientation detector.

The orientation detector detects a relative orientation of a lighting device. In some examples, the orientation is detected relative to a predefined reference plane, or relative to the direction of a gravity force vector. For example, using the reference plane or vector, the orientation detector can detect a change in orientation of the lighting device relative to a predefined baseline orientation of the lighting device. In some examples, the orientation detector can be an accelerometer that detects changes in inclination of the lighting device relative to the force of gravity.

The orientation detector can feed signals carrying information about the detected orientation to the controller of the lighting system, which processes the orientation signals and controls the light emitters accordingly, e.g., by activating the at least one light emitter and deactivating the at least one light emitter in response to a changed inclination away from a baseline inclination.

As illustrated, the various embodiments described herein can include a system memory. The memory can provide non-volatile, non-transitory storage for the device. The memory can store instructions that are executed by the controller to perform one or more functions or acts, such as those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A lighting system, comprising:
a lighting device, the lighting device including:
a housing;
a lens mounted to the housing;
a first reflector positioned in the housing; and
a light emitter positioned in the housing, the lighting device being configured such that a peak magnitude of a light beam distribution emitted by the light emitter through the lens is along a first direction; and
a second reflector configured to be mounted to the lighting device, the second reflector being configured such that when the second reflector is mounted to the lighting device, the peak magnitude of the light beam distribution emitted by the light emitter through the lens is along a second direction, the second direction and the first direction being at least 5 degrees offset from each other.

2. The lighting system of claim 1, wherein the second reflector is configured to be mounted to the lighting device such that the second reflector at least partially covers the first reflector.

3. The lighting system of claim 1, wherein the second reflector is configured to be mounted to the lighting device such that the second reflector fully covers the first reflector.

4. The lighting system of claim 1, wherein the light emitter includes a light emitting diode (LED).

5. The lighting system of claim 1, wherein the second direction and the first direction are between 5 degrees and 20 degrees offset from each other.

6. The lighting system of claim 1, wherein the second direction and the first direction are between 13 degrees and 17 degrees offset from each other.

7. The lighting system of claim 1,
wherein the first reflector includes a first configuration of first curved surfaces;
wherein the second reflector includes a second configuration of second curved surfaces; and
wherein the first configuration of first curved surfaces is different from the second configuration of second curved surfaces.

8. The lighting system of claim 7, wherein first elongate dimensions of the first curved surfaces are approximately perpendicular to second elongate dimensions of the second curved surfaces when the second reflector is mounted to the lighting device.

9. The lighting system of claim 1, wherein the first curved surfaces are concave and the second curved surfaces are not concave.

10. The lighting system of claim 1,
wherein the second reflector includes mounting structures;
wherein the housing defines receivers; and
wherein the mounting structures are configured to lockingly mate with the receivers.

11. The lighting system of claim 1,
wherein the lighting device further comprises a printed circuit board (PCB) positioned within the housing; and
wherein the light emitter is mounted to the PCB.

12. A lightbar for a vehicle, comprising:
a housing;
a lens mounted to the housing;
a first light assembly positioned in the housing, the first light assembly including a first light emitter and a first reflector;
a second light assembly positioned in the housing, the second light assembly including a second light emitter and a second reflector,
wherein the first light emitter and the second light emitter are configured to generate light beams having light beam distributions in which directions of peak magnitudes of the light beam distributions are parallel to each other; and
wherein the first reflector and the second reflector are configured to reflect the light beams such that reflected directions of the peak magnitudes of the light beam distributions are offset from each other by at least 5 degrees.

13. The lightbar of claim 12, wherein the first reflector and the second reflector are configured to reflect the light beams such that reflected directions of the peak magnitudes of the light beam distributions are offset from each other by between 5 degrees and 20 degrees.

14. The lightbar of claim 12, wherein the first reflector and the second reflector are configured to reflect the light beams such that reflected directions of the peak magnitudes of the light beam distributions are offset from each other by between 13 degrees and 17 degrees.

15. The lightbar of claim 12,
wherein the first reflector includes a first configuration of first curved surfaces;
wherein the second reflector includes a second configuration of second curved surfaces; and
wherein the first configuration of first curved surfaces is different from the second configuration of second curved surfaces.

16. The lightbar of claim 15, wherein first elongate dimensions of the first curved surfaces are approximately perpendicular to second elongate dimensions of the second curved surfaces.

17. The lightbar of claim 15, wherein the second curved surfaces in cross-section define a portion of a parabola.

18. The lightbar of claim 12,
further comprising a printed circuit board (PCB) positioned within the housing,
wherein the first light emitter and the second light emitter are mounted to the PCB.

19. A vehicle, comprising:
a vehicle body; and
the lightbar of claim 12 mounted to the vehicle body.

20. The vehicle of claim 19,
wherein the vehicle body includes a tiltable bed; and
wherein the lightbar is mounted to the tiltable bed.
